(19) United States
(12) Patent Application Publication
(10) Pub. No.: US 2006/0057290 A1
(43) Pub. Date: Mar. 16, 2006

(54) Patterning carbon nanotube coatings by selective chemical modification

(76) Inventor: Paul J. Glatkowski, Littletown, MA (US)

Correspondence Address: Intellectual Property Group;Powell Goldstein LLP, Third Floor, 901 New York Avenue, N.W., Washington, DC, 20001, US

(21) Appl. No.: 11/124,382

(22) Filed: May 9, 2005

Related U.S. Application Data
(60) Provisional application No. 60/568,693, filed on May 7, 2004.

(51) Int. Cl. B05D 5/00; B32B 9/00

(52) U.S. Cl. 427/256; 427/532; 428/408

(57) ABSTRACT

This invention is directed to a method of patterning carbon nanotubes transparent electrically conductive coating/films, by modification of the applied carbon nanotube (CNT) network through use of sidewall group functionalization to disrupt electrical conductivity of the nanotubes. The resulting areas which undergo chemical modification are rendered more or less conductive than those areas which where not altered. This results in a patterned film, wherein said pattern is shaped to form electrodes, pixels, wires, antenna or other electrical component. In addition, the areas of chemically modified CNT can be returned to their original conductive state (i.e. reversible and repeatable), or fixed to yield a permanent pattern.

### REFERENCE TO RELATED APPLICATIONS

This application claims priority to U.S. Provisional application No. 60/568,693, entitled Methods of Patterning Carbon Nanotube Coatings Using Selective Chemical Modification, filed May 7, 2004, the entirety of which is hereby specifically incorporated by reference.

### BACKGROUND

1. Field of Invention

This invention is directed to a method of patterning carbon nanotubes transparent electrically conductive coatings and films by modification of an applied carbon nanotube network with sidewall functionalization to disrupt electrical conductivity of the nanotubes. The invention is further directed to the resulting patterned carbon nanotube networks.

2. Description of the Background

Numerous electronic devices require electrical conductors which are optically transparent to visible light. The transparent electrical conductors function by transmitting electrical power to operate user interfaces like touch screens or to send a signal to a pixel in a LCD display. Transparent conductors are an essential component in many optoelectronic devices including flat panel displays, touch screens, electroluminescent lamps, solar panels, “smart” windows, and OLED lighting systems. In all these applications, the user must see through the conductive layer to perform an operation. In addition, transparent patterned conductors are valuable in making biometric identification cards, i.e., Smart cards in which the information is stored in or transfer thought the conductive layer. The use of transparent conductive layers in such cards is advantageous for security purposes since it is difficult to find the information. Future electronic devises are limited in function and form by the current materials and processes utilized to create electrically conductive transparent layers. There exists a need for electrically conductive optically transparent coatings and films, which are more transparent, equally conductive, processed using large area patterning and ablative techniques, flexible and wholly low cost.

Today most transparent electrodes are made from transparent conducting oxides, such as indium tin oxide (ITO), and have been the preferred choice for four decades. ITO is applied to an optically transparent substrate by vacuum deposition and then patterned using costly photolithographic techniques to remove excess coating and form the wire and electrodes. Both of the processes are difficult and expensive to scale up to cover large areas. ITO also has some rather significant limitations: 1) ITO films are brittle (mechanical reliability concern for flexible applications such as in plastic displays, plastic solar voltaic, and wearable electrical circuitry.); and 2) ITO circuits are typically formed by vacuum sputtering followed by photolithographic etching (fabrication cost may be too high for high volume/large area applications).

Efforts have been made to provide transparent electrodes to replace ITO film. A typical example is a suspension of ITO particles in a polymer binder. However, this ITO-filled system cannot match the electrical conductivity of a continuous ITO film. Furthermore, transparent conductive polymer materials are now being developed. These polymers typically require dopants to impart conductive properties, and are applied on a substrate using screen printing or ink jet application technique. Although they are still at a development stage, and yet to reach the conduction level of a ITO film, the presence of dopants is expected to have an adverse effect on controlling the conductive properties, and may not be compatible with device miniaturization.

Thus, an efficient, rapid and cost-effective method for forming coatings that have desired patterns of electrical conductivity is needed, as are improved products from these methods.

### SUMMARY OF THE INVENTION

The present invention overcomes the problems and disadvantages associated with existing subtractive and additive methods for creating electrically conductive coating patterns.

One embodiment of the invention is directed to methods of patterning an electrically conductive coating of a surface comprising applying carbon nanotubes to said surface to form a coating and exposing areas of said coating to a reagent that modifies electrical conductivity, either by increasing or reducing conductivity, of only said areas by functionalizing carbon nanotube sidewall groups. Applying may comprises spraying, roll coating, vacuum deposition, and combinations of such methods as well as other well known coating processes. The carbon nanotubes are conductive, semi-conductive or a combination of both, and selected from the group comprising single-wall, double-wall, multi-wall and combinations thereof. Reagent may comprises ultraviolet light at an intensity sufficient to functionalize the carbon nanotube sidewall groups, and a photoreactive chemical such as osmium tetraoxide in the presence of oxygen. Carbon nanotube sidewall groups may be functionalized by cycloaddition, such as of an osmyl ester or a quinine-type functionality. The patterned electrically conductive coating may form an electrical circuit.

Another embodiment of the invention is directed to reversible patterning according to the invention, wherein reversing the patterning comprises exposing the coating to UV light in the presence of oxygen and the absence of the reagent.

Another embodiment of the invention is directed to fixing patterning according to the invention, wherein fixing the patterning comprises exposing the coating to water such as water vapor in ambient air.

Another embodiment of the invention is directed to patterned electrically conductive coatings made by the methods of the invention.

Another embodiment of the invention is directed to methods of selectively pattering a carbon nanotube coating comprising exposing the coating to ultraviolet light and a chemical reagent that functionalizes carbon nanotube sidewall groups. Useful chemical reagents include osmium tetroxide and oxygen, wherein the oxygen comprises oxygen dissolved in a solvent. Coatings may further be over-coated with a patterned conductor by applying a polymeric or inorganic binder to provide environmental protection to the conductive layer.

Another embodiment of the invention is directed to methods of patterning an electrically conductive coating of a surface comprising applying carbon nanotubes to said surface to form a coating and exposing areas of said coating to a reagent that modifies electrical conductivity, either by increasing or reducing conductivity, of only said areas by functionalizing carbon nanotube sidewall groups, wherein the reagent comprises a diazonium reagent. Useful diazonium reagents include 4-bromobenzenediazonium tetrafluoroborate, 4-chlorobenzenediazonium tetrafluoroborate, 4-fluorobenzenediazonium tetrafluoroborate, 4-tert-butylbenzenediazonium tetrafluoroborate, 4-nitrobenzenediazonium tetrafluoroborate, 4-methoxycarbonylbenzenediazonium tetrafluoroborate, 4-tetradecylbenzenediazonium tetrafluoroborate, and combinations thereof. The chemical reagent selectively functionalizes carbon nanotube sidewall groups to form patterns.

Another embodiment of the invention comprises patterned carbon nanotube coating made by the method of the invention. A patterned coating can be applied to a transparent, conductive layer for storage of information. The information stored may comprise personal information of one or more persons, professional information, company information, recreational information, dictionary information, business records or combinations thereof.

Other embodiments and advantages of the invention are set forth in part in the description, which follows, and in part, may be obvious from this description, or may be learned from the practice of the invention.

### DESCRIPTION OF THE INVENTION

Most transparent electrodes are made from transparent conducting metal oxides, such as indium tin oxide (ITO). Basically, ITO is applied to an optically transparent substrate and patterned using costly photolithographic techniques to remove excess coating and form the wire and electrodes. The processes are difficult and expensive to perform over large areas. Efforts have been made to provide transparent electrodes to replace ITO film. A typical example is a suspension of ITO particles in a polymer binder. This ITO-filled system cannot match the electrical conductivity of a continuous ITO film.

An alternative to metal oxide coatings is coatings of carbon nanotubes (CNT). CNTs can form conductive networks on a coated surface. These coatings are formed using low cost, large area, traditional wet coating processes, such as, but not limited to, spraying, dipping and roll coating. Such coatings can be patterned during deposition by applying the CNTs only where needed with a selective process such as inkjet printing, silk screen printing, gravure coating and other conventional coating processes known to those skilled in the art. Through the controlled application of this network of nanotubes by means of printing or spraying, patterned areas can be formed to function as electrodes in devices. The use of printing technology to form these electrodes obviates the need for more expensive process such as vacuum deposition and photolithography typically employed today during the formation of an ITO coating. An alternative to selective deposition is to apply a continuous CNT coating to a surface, followed by ablation or subtraction of CNT's one or more areas to form a pattern. For example, laser etching can selectively remove the CNT where not desired to leave a pattern.

Carbon nanotubes are known and have a conventional meaning (R. Saito, G. Dresselhaus, M. S. Dresselhaus, “Physical Properties of Carbon Nanotubes,” Imperial College Press, London U.K. 1998, or A. Zettl “Non-Carbon Nanotubes” Advanced Materials, 8, p. 443, 1996). Carbon nanotubes comprises straight and/or bent multi-walled nanotubes (MWNT), straight and/or bent double-walled nanotubes (DWNT), and straight and/or bent single-walled nanotubes (SWNT), and combinations and mixtures thereof. CNT may also include various compositions of these nanotube forms and common by-products contained in nanotube preparations such as described in U.S. Pat. No. 6,333,016 and WO 01/92381, and various combinations and mixtures thereof. Carbon nanotubes may also be modified chemically to incorporate chemical agents or compounds, or physically to create effective and useful molecular orientations (for example see U.S. Pat. No. 6,265,466), or to adjust the physical structure of the nanotube.

Types of nanotubes that are useful include single walled carbon-based SWNT-containing material. SWNTs can be formed by a number of techniques, such as laser ablation of a carbon target, decomposing a hydrocarbon, and setting up an arc between two graphite electrodes. For example, U.S. Pat. No. 5,424,054 to Bethune et al. describes a process for producing single-walled carbon nanotubes by contacting carbon vapor with cobalt catalyst. The carbon vapor is produced by electric arc heating of solid carbon, which can be amorphous carbon, graphite, activated or decolorizing carbon or mixtures thereof. Other techniques of carbon heating are discussed, for instance laser heating, electron beam heating and RF induction heating. Smalley (Guo, T., Nikoleev, P., Thess, A., Colbert, D. T., and Smally, R. E., Chem. Phys. Lett. 243: 1-12 (1995)) describes a method of producing single-walled carbon nanotubes wherein graphite rods and a transition metal are simultaneously vaporized by a high-temperature laser. Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) also describes a process for production of single-walled carbon nanotubes in which a graphite rod containing a small amount of transition metal is laser vaporized in an oven at about 1,200° C. Single-wall nanotubes were reported to be produced in yields of more than 70%. U.S. Pat. No. 6,221,330 discloses methods of producing single-walled carbon nanotubes which employs gaseous carbon feedstocks and unsupported catalysts.

Films made of carbon nanotubes are known to have surface resistances as low as 10² ohms/square. U.S. Pat. No. 5,853,877, entitled “Method for Disentangling Hollow Carbon Microfibers, Electrically Conductive Transparent Carbon Microfibers Aggregation Film and Coating for Forming Such Film,” describes formation of such conductive carbon nanotube films, and U.S. Pat. No. 6,221,330, entitled “Processing for Producing Single Wall Nanotubes Using Unsupported Metal Catalysts,” generally describes production of such carbon nanotubes used for forming the conductive films. However, there have been no reports in the art on a method for patterning the film made of carbon nanotubes.

Coatings comprising carbon nanotubes such as carbon nanotube-containing films have been previously described (see U.S. patent application Ser. Nos. 10/105,623; 10/201,568; 10/105,618; 10/442,176; 10/729,369; 10/978,212; and U.S. Pat. Nos. 6,493,208; 6,762,237). Such films may have a surface resistance as low as 10² ohms/square (ranging from 10⁰ ohms/square to 10⁶ ohms/square or more) and a total light transmittance as high as 95% (ranging from 60% to 99% or better). The content of the carbon nanotubes in the film may be as high as 50% (ranging from 0.001% to 50%).

Such materials can be formed by a two step method, which results in carbon nanotube film that have a low electrical resistance as well as a high light transmittance. First, a dilute water solution of carbon nanotubes is sprayed on a substrate, and water is evaporated leaving only the consolidated carbon nanotubes on the surface. Then, a resin is applied on the consolidated carbon nanotubes and penetrates into the network of the consolidated carbon nanotubes.

Carbon nanotubes were found from electron microscopic observation in 1991 by Dr. Iijima at Maijo University, Japan. Since then, carbon nanotubes have received profound studies. Typically, a carbon nanotube is like a hollow cylinder made of a graphite sheet, whose inner diameter ranges from 1 to 20 nm. Graphite has been known to have a peculiar structure. That is, the covalent bonds between carbon atoms constituting graphite are arranged in an unusual style, so that graphite has a shape of rigid, flat hexagonal sheet. The upper and lower regions of the sheet are filled with dispersed free electrons, which translate in a parallel to the plain of the sheet. Carbon nanotubes are a recently identified carbon form in which a tube consists of a single graphite sheet with helical structure dependant on the arrangement of the graphitic sheet. Electric properties of the carbon nanotube are in functional relation with the helical structure and diameter thereof (Phys. Rev. (1992) B46:1804 and Phys. Rev. Lett. (1992) 68:1579). Thus, an alteration of either helicity or chirality of the carbon nanotube results in a change of motion of the free electrons. Consequently, free electrons are allowed to move freely as in a metallic material, or they have to overcome an electronic band gap barrier as in a semiconductive material depending on the structure of the tube.

In addition, any modifications to the carbon atoms forming the sidewalls of these tubes will consequently modify the electrical properties of the tube. Semiconductive carbon nanotubes can be chemically doped with electron donating or electron withdrawing chemicals to produce a tube with metallic-like conduction. Furthermore, metallic nanotubes can be transformed in to poor conductors by damaging the sidewalls, chemical reactions to the sidewalls, irradiation with electrons or other high energy particles.

The electrical properties of the SWNT change dramatically as they are functionalized. The untreated SWNT are essentially metallic and their two point resistance (essentially a contact resistance, Bozhko, et al., 1998, Appl. Phys. A, 67:75-77) measured across 5 mm of the “bucky paper” surface is 10-15 Ohms. When fluorinated, the tubes become insulating and the two point resistance exceeds 20 MOhms. Methods of fluorinating carbon nanotubes are described in U.S. Pat. 6,645,455, Margrave et al. After methylation the tubes possess a two point resistance of .about.20 kOhms. Pyrolysis of the methylated product brings the resistance down to .about.100 Ohms. Incomplete return of the electrical conductivity upon pyrolysis may be due to an increased contact resistance that results from disorder induced into the rope lattice following the sequence of reaction steps. The usefulness of this approach to selectively pattern carbon nanotube coatings is severely limited by the reaction conditions, which limit the ability to selectively control the placement of the patterns and to process coatings on standard substrates such as plastic and glass which will also be modified by the same reaction conditions that cause the fluorination of the nanotubes.

Many methods of forming patterned carbon nanotube coatings on substrates are conventionally available. Typical approaches either create the pattern by subtracting the excess material from at continuous coating of nanotubes on the substrate or create the pattern additively by applying the nanotubes directly onto the substrate in the form of the pattern leaving uncoated areas to act as the insulation between the conductive pathways.

For example, U.S. patent application Publication No. 20040265755 relates to a method of making carbon nanotube patterned film or carbon nanotube composite using carbon nanotubes surface-modified with polymerizable moieties. This approach does not lead to electrically conductive coatings with low electrical resistance since all the nanotubes are chemically functionalized on the sidewalls and are dispersed in polymer during deposition which disrupts formation of the nanotube conductive network. In this disclosure the deposited nanotube/polymer layer is later subtracted selectively through photolithography methods.

U.S. patent application Publication No. 20020025374 relates to a selective growth method on a substrate to form patterned carbon nanotubes. This is a type of additive approach of growing the nanotubes directly on a surface at high temperatures greater than 500° C. This limits the use of this technology to high temperature substrates and doe not scale easily to allow production of large parts or continuous films. Similarly in U.S. Pat. No. 6,858,197, Delzeit, is disclosed a patterning methods wherein the nanotube are selectively grown on a substrate to form a pattern. This method first patterns a polymer on a surface and then grows the nanotubes on areas where the polymer was not deposited thereby creating a nanotube patterned surface with the unique feature of also providing aligned nanotubes in the pathways. This method also suffers from requiring high temperatures to form the nanotubes and is restricted in the size of the coated substrate which can be processed due to limitation of vacuum chamber size.

U.S. Pat. No. 6,835,591 relates to nanotube films made by subtractive removal methods of forming conductive patterned films of carbon nanotubes. However modification of the nanotubes chemically to switch the electronic state of the nanotubes is not disclosed as a way of form patterns from continuous coatings of nanotubes. Furthermore the subtractive methods describe this disclosure are not reversible and are easily detected by the optical appeared change between regions with nanotubes and regions where the nanotube are removed as in the present invention.

The present invention overcomes the problems and disadvantages associated with existing subtractive and additive methods for patterning nanotube coatings by exploiting chemical modification along the sidewall of carbon nanotubes to selectively change parts of the CNT coating from conductive to less conductive thereby forming a electrical circuit or pattern a continuous coating of CNT on a substrate. Additionally, the process of selective switching the nanotube coating from conductive to less conductive is reversible by this method. This allows the removal and/or rearrangement of the pattern without removal or addition of CNT from the surface. All other know methods of forming patterns or circuits of CNT require ether removal or addition of CNT to alter the pattern. The present method allows the use of a single layer of CNT to be addressed repeatedly to store information or redesign a circuit o the surface. This is of particular utility for storing data without leaving a noticeable physical change such as in appearance, thereby making the circuit or patterning indiscernible or secrete on the surface.

One embodiment of the invention is directed to methods for forming metallic CNT that provide electrical conductivity in a coating. Such nanotubes may be a target for chemical modification that can increase or decrease electrical conductivity of the network. The nanotube coating may contain either or both semi-conductive nanotubes or metallic nanotubes. The sidewall chemical modification, or functionalization, is the result of covalent bonds formed during photochemical reaction between the carbon nanotube side wall groups and a reagent. Conductivity can be altered for the CNTs of the desired pattern or, alternatively, for the CNTs of the reverse image of the desired pattern, in other words the non-patterned areas only. As such, complex patterns can be created. Also, coating may be combined and layer together or in combination with commercially available circuits and conductivity patterns creating multiple layers of patterned structures.

Functionalized nanotubes may have an electrical resistivity at least 10× greater, preferably 100× greater, more preferably 1,000× greater, and even more preferably 10,000× greater. Alternatively, functionalized nanotubes may have an electrical resistivity that is at least 10× less, preferably 100× less, more preferably 1,000× less, and even more preferably 10,000× less.

In one form of patterning, a chemical reagent, such as, but not limited to, osmium tetroxide(OsO₄), in the presence of oxygen and UV light at about 254 nm (effective for functionalization), functionalizes carbon nanotube sidewall groups. UV light introduces defects into the covalent bond of the CNT sidewall that destroy the periodicity of the intrinsic conjugated sp2 electronic structure of the nanotube. Coatings are typically exposed to reactants and photoexcitation without the presence of other compounds that may interfere such as polymers, surfactants, dispersants, dopants and similar compounds known to those skilled in the art. In addition, side wall groups can be modified by ozonolysis. Other useful chemical reagents that functionalize carbon nanotube side wall groups include most commercially available photoreactive reagents. Chemical reagents that functionalize carbon nanotube side wall groups include reagents that covalently bind to the side wall groups. Many such reagents and the types of functionalization chemistry that can be used is disclosed in U.S. patent application Publication Nos. 20040071624; 20050074390; 20050034629; 20020144912 and 20030095914; and U.S. Pat. Nos. 6,740,151; 6,576,747; 6,555,175; 6,494,946; 6,435,240; 6,042,643; 5,900,029; 5,883,253; 5,851,280, 5,554,739 and 5,547,806.

The traditional method for form transparent conductive coating with carbon nanotubes is to compound the CNT into a polymer resin and then form the coating. The resulting CNT are embedded and not available for sidewall functionalization or chemical reaction. However in the present invention, the CNT are deposited using only fugitive fluids to disperse the nanotubes onto the surface. The fluids then are removed by evaporation, sublimation, and/or other methods of inducting phase change from liquid to vapor (i.e. fugitive). Once dried, the deposited layer consists of only CNT and open space typically occupied by air or other gas. At this stage, the entire or part of the substrate is coated with an open CNT network susceptible to infiltration by chemical reagents suitable for modifying the electronic structure of the individual and/or collective ensemble of nanotubes.

Another embodiment of the invention is directed to metallic CNT coatings that provide electrical conductivity in a coating formed by the methods of the invention.

A method for patterning CNT coatings is disclosed herein which overcomes many limitations imposed by the methods describe previously. In this method a uniformly CNT coated substrate, absent binder coating, is exposed selectively to chemical reactants which alter the electrical properties of the nanotubes making the conductive network such as to render them less conductive than the nonexposed areas of the coating. The resulting coating can be exposed to form a pattern useful for device manufacture. In addition the patterned coating can be exposed again to reverse the process resulting a coating with uniform conductivity, just as it started. Alternatively the exposed and patterned coating can be fixed, such that the pattern is permanent, irreversible. No other patterning methods offer this level of process and design flexibility. The patterns formed by this method are unique in that the entire surface remains covered with CNTs, making the detection of the conductive pattern very difficult since only the electronic nature of the coating is altered. The result is a transparent conductive pattern with uniform smoothness (e.g. flatness), and optical uniformity.

To make use of sidewall chemical modifications of nanotubes to form patterns, the nanotube can be exposed to reagents. A two step coating method can form the base coating of nanotubes. A preferred method for forming the initial CNT coating is to deposit the nanotube from a solution/ink containing fugitive solvents and dispersing agents and more preferred only such solvents and agents. In this way, the ink is deposited, using traditional coating technologies like spraying, and dried on the surface to form a network of nanotubes devoid of other compounds. Preparation of the CNT coating is prior to patterning.

A second aspect of this invention is to form patterned electrical conductors on a surface by selectively utilizing published chemical reactions which covalently modify the sidewall of CNTs and thereby reduce electrical conductivity. Examples of this invention are disclosed in, but not limited to, the following embodiments and examples.

### Embodiment 1

The first method for forming a patterned coating is to expose a pure CNT coating to both OsO₄ and O₂ gases, in an inert gas carrier/environment. Arc produced SWNT soot is first purified by process steps including acid reflux, water rinsing, centrifuge and microfiltration. Then, the purified SWNTs are mixed into a 3:1 solution of isopropyl alcohol (IPA) (other types of alcohols may also be used such as methanol, ethanol, propanol, butanol, etc.) and water to form a carbon nanotube coating solution. The soot, containing approximately 50-60% carbon nanotubes, purified by refluxing in 3M nitric acid solution for 18 hours at 145±15° C., and then washed, centrifuged and filtered. The purified mixture produces an ink solution containing greater than 99% single walled carbon nanotubes at a concentration of roughly 0.059 g/L. A coating of CNT is formed by simply spray coating, or another conventional method of solution deposition, this ink onto a surface and drying to obtain a pure layer of CNT.

The chemical reaction proceeds once UV light is exposed onto the surface of the CNT. Since the UV light is exposed in a pattern, the reaction only occurs in selectively in the areas were UV light photoinitiates chemical attack of the CNT sidewall by cycloaddition of the OsO₄. Interestingly, the reaction occurs on the metallic CNT and not on the semiconductive CNT sidewalls.

Once the metallic CNT forming the coating are modified the electrical resistivity is much lower than those not exposed to the full reaction condition. At this point in the process the opportunity exist to reverse the reaction and return the modified CNT back into conductive CNT by re-exposing the coating to UV and O₂ (as a gas) (without OsO₄ present). Alternatively, a UV and vacuum can be used to reverse the reaction, however the conversion time is much longer. This creates the opportunity to repeatedly switch the transparent conductive layer on and off electrically.

If reversibility is not desirable and instead a fixed or permanent patterned coating is needed, then the patterned coating is exposed to water vapor (e.g. ambient air contains sufficient water vapor) to initiate a second chemical reaction wherein the osmium dioxide covalent bond to the sidewall of the CNT is converted into an osmyl ester or quinine-type functionality. The result is that the side wall of the CNT is modified to effectively switch off the electrical conductivity.

The utility of this method for patterning are many, which includes, but is not limited to:
Patterning resolution is only limited by the detail of the UV image projected onto the coating and the size of the nanotube bundles.
The reagents (OsO₄, O₂, H₂O, and carrier gases Ar or N₂) are all gaseous in form, and therefore are easily transported to and from the coating surface, rendering a pure CNT network which can be subsequently filled or coated with a binder.
The reagents can also be applied with solvents in liquid form.
The modified CNT can be reverted to their initial conductive state without loss by re-exposure to water vapor or other reactant.
The patterned coating can be fixed permanently, locking in the pattern.
The patterned coating can be infiltrated with polymers to bind the layer in place in the substrate. This binder resin can be selected to provide environmental protection to the conductive layer.
Multiple layers of CNT and binder can be stacked to build multilayer circuits or devices.

The individual layer will not interfere.

The reaction mechanism and other details of the chemistry are provided in Nano Letters, 2003, Vol. 3, No. 5, pages 613-615. Also a detailed and informative description is found in J. Am. Chem. Soc. 2004, 126, pages 2073-2091.

### Embodiment 2

The chemical modification of CNT sidewalls is accomplished by other types of reactions known in the literature. These reactions are not photoinitiated and the pattern is formed by selective applying the reagents to modify the CNT. The concept is the same wherein chemical reagents are applied to an existing coating of CNT to selectively alter the electrical properties of the conductive layer. The reagent coated CNT layer is reacted to the SWNTs. Typically a solvent rinsing step would be required to remove excess reactants and byproducts from the coating. Examples of effective reagents are provided below.

The following examples illustrate embodiments of the invention, but should not be viewed as limiting the scope of the invention.

### EXAMPLE 1

### Reagent is Diazonium Salts

To form a coating of CNT on a substrate, first Arc produced SWNT soot is purified by process steps including acid reflux, water rinsing, centrifuge and microfiltration. Then, the purified SWNTs are mixed into a 3:1 solution of isopropyl alcohol (IPA) (or other alcohols) and water to form a carbon nanotube coating solution. (The soot, containing approximately 50-60% carbon nanotubes, purified by refluxing in 3M nitric acid solution for 18 hours at 145±15° C., and then washed, centrifuged and filtered). The purified mixture produces an ink solution containing greater than 99% single walled carbon nanotubes at a concentration of roughly 0.059 g/L. A coating of CNT can be formed by simply spray coating, or any other method of solution deposition, this ink onto a surface and drying to obtain a pure layer of CNT.

Selective functionalization of CNT is accomplished by reaction with diazonium reagents. Refer to Science Vol. 301, 12 Sep. 2003, page 1519-1522, also see U.S. patent application Publication No. 20040071624A1. This reaction is analogous to that of the osmium in that sidewall functionalization occurs which renders the CNT less conductive. Useful diazonium reagents include 4-bromobenzenediazonium tetrafluoroborate, 4-chlorobenzenediazonium tetrafluoroborate, 4-fluorobenzenediazonium tetrafluoroborate, 4-tert-butylbenzenediazonium tetrafluoroborate, 4-nitrobenzenediazonium tetrafluoroborate, 4-methoxycarbonylbenzenediazonium tetrafluoroborate, 4-tetradecylbenzenediazonium tetrafluoroborate, and combinations thereof. By way of example, the following diazonium salts are also useful: 1: 4-nitrobenzenediazonium tetrafluoroborate; 3,3′-dimethoxybiphenyl-4,4′-bis(diazonium) dichloride; 4-carboxymethylbenzenediazonium tetrafluoroborate; 1,4-benzenebis(diazonium) tetrafluoroborate; chlorobenzyl-4-diazonium tetrafluoroborate; and diazonium salts chosen from 4-chloromethylphenyldiazonium; 4-hydroxymethylphenyldiazonium; 4-carboxyphenyldiazonium; 4-formylphenyldiazonium; 4-acetylphenyldiazonium; 4-isothiocyanatophenyld-iazonium; 4-N-FMOC-aminomethylphenyldiazonium; 4-(4-hydroxymethylphenoxyme-thyl)phenyldiazonium; 4-(2,4-dimethoxyphenyl-N-FMOC-aminomethyl)phenyldiaz-onium; 4-(phenyl-N-FMOC-aminomethyl)phenyldiazonium; 4-(4-methylphenyl-N-FMOC-aminomethyl)phenyldiazonium and 4-(4-nitrophenylcarbonyl)phenyldiazonium salts; trityldiazonium chloride, 2-chlorotrityldiazonium chloride; trityldiazonium hydroxide; 9-N-FMOC-aminoxanthen-3-yldiazonium; 4-(2,4-dimethoxyphenylhydroxymethyl)-phenyldiazonium; 4-(4-hydroxymethylbenzoyloxymethyl)phenyldiazonium; 4-(4-hydroxymethylbenzoylaminomethyl)phenyldiazonium; 4-(4-hydroxymethyl-3-methoxyphenoxymethyl)phenyldiazonium; and salts thereof.

### EXAMPLE 2

### Reagent is Bromine and Surfactants

Selective functionalization of metallic CNT is accomplished by reaction with Bromine reagents, which are know to form charge transfer complexes with CNT, more preferable with metallic CNT. For detailed description of the chemistry, see Nano Letters 3, 2003, page 1245.

### EXAMPLE 3

### Reagent is Fluorine and Surfactants

Selective functionalization of metallic CNT is accomplished by reaction with fluorine reagents, which are know to functionalize the sidewall of CNT, more preferable with metallic CNT. This invention provides a method for derivatizing carbon nanotubes comprising reacting carbon nanotubes with fluorine gas, the fluorine gas preferably being free of HF. For detailed description of the chemistry, see U.S. Pat. No. 6,645,455. This reaction is analogous to that of the osmium in that sidewall functionalization occurs which renders the CNT less conductive.

Where the carbon nanotubes are single-wall nanotubes, and the temperature is at least 500° C., the product may be multiple wall carbon nanotubes, derivatized with fluorine. Where the carbon nanotubes are single wall nanotubes, and the temperature is between 250° C. and 500° C., the product is single wall carbon nanotubes having fluorine covalently bonded to carbon atoms of the side wall groups of the nanotube.

### EXAMPLE 4

### Derivatization with Aryl-Diazonium

Derivatization with aryl diazonium species can be induced photochemically. A photochemical reaction is performed utilizing 4-chlorobenzenediazonium tetrafluoroborate. A suspension of SWNT-p in 1,2-dichlorobenzene is created by sonication. To this suspension is added a portion of the diazonium salt dissolved in minimal acetonitrile. The resulting mixture is stirred while residing within the chamber of a photochemical reaction apparatus, with an excitation wavelength of ca. 254 nm (an ultraviolet light source). The light source for the photochemically induced reaction is any wavelength, and typically is an ultraviolet or visible wavelength. The resultant material is similar in all respects to SWNT-2 that is prepared by an electrochemical technique. This experiment further confirms that reaction of the diazonium salt leads to covalent attachment to the nanotube. A variety of aryl diazonium salts for modification can be utilized to modify carbon nanotube side walls, as well as alkyl, alkenyl and alkynyl additions could be used for the process of the invention. Additionally, parameters such as added potential, the duration of the applied potential, the solvent, and the supporting electrolyte can be varied.

Other embodiments and advantages of the invention are set forth, in part, in the following description and, in part, may be obvious from this description, or may be learned from the practice of the invention. All references cited herein, including all publications, U.S. and foreign patents and patent applications, are specifically and entirely incorporated by reference. It is intended that the specification and examples be considered exemplary only with the true scope and spirit of the invention indicated by the following claims.

1. A method of patterning an electrically conductive coating of a surface comprising:
applying carbon nanotubes to said surface to form a coating;
exposing areas of said coating to a reagent that modifies electrical conductivity of only said areas by functionalizing carbon nanotube sidewall groups.

2. The method of claim 1, wherein applying comprises spraying, roll coating, vacuum deposition, and combinations thereof.

3. The method of claim 1, wherein the carbon nanotubes are conductive, semi-conductive or a combination of both.

4. The method of claim 1, wherein the carbon nanotubes are selected from the group consisting of single-wall, double-wall, multi-wall and combinations thereof.

5. The method of claim 1, wherein the reagent comprises ultraviolet light at an intensity sufficient to functionalize the carbon nanotube sidewall groups.

6. The method of claim 5, wherein the reagent further comprises a photoreactive chemical.

7. The method of claim 6, wherein the photoreactive chemical is osmium tetraoxide in the presence of oxygen.

8. The method of claim 1, wherein the carbon nanotube sidewall groups are functionalized by cycloaddition.

9. The method of claim 8, wherein the cycloaddition is of an osmyl ester or a quinine-type functionality.

10. The method of claim 1, wherein the modification reduces electrical conductivity along said areas.

11. The method of claim 1, wherein the modification increases electrical conductivity along said areas.

12. The method of claim 1, wherein the patterned electrically conductive coating forms an electrical circuit.

13. The method of claim 1, wherein the patterning is reversible.

14. The method of claim 13, wherein reversing the patterning comprises exposing said coating to UV light in the presence of oxygen and the absence of the reagent.

15. The method of claim 1, wherein the patterning is fixed by exposing the coating to water.

16. A patterned electrically conductive coating made by the method of claim 1.

17. A method of selectively pattering a carbon nanotube coating comprising:
exposing the coating to ultraviolet light and a chemical reagent that functionalizes carbon nanotube sidewall groups.

18. The method of claim 17, wherein the chemical reagent comprises osmium tetroxide and oxygen.

19. The method of claim 18, wherein the oxygen comprises oxygen dissolved in a solvent.

20. The method of claim 17, further comprising permanently fixing the patterning by exposing the coating to water vapor.

21. The method of claim 17, further comprising removing the patterning by exposing said coating to oxygen and UV light.

22. The method of claim 17, further comprising over-coating said carbon nanotube coating with a patterned conductor comprising applying a polymeric or inorganic binder to provide environmental protection to the conductive layer.

23. The method of claim 17, wherein the chemical reagent comprises a diazonium reagent.

24. The method of claim 23, wherein the diazonium reagent is selected from the group consisting of 4-bromobenzenediazonium tetrafluoroborate, 4-chlorobenzenediazonium tetrafluoroborate, 4-fluorobenzenediazonium tetrafluoroborate, 4-tert-butylbenzenediazonium tetrafluoroborate, 4-nitrobenzenediazonium tetrafluoroborate, 4-methoxycarbonylbenzenediazonium tetrafluoroborate, 4-tetradecylbenzenediazonium tetrafluoroborate, and combinations thereof.

25. The method of claim 17, wherein the chemical reagent selectively functionalizes carbon nanotube sidewall groups to form patterns.

26. A patterned carbon nanotube coating made by the method of claim 17.

27. The coating of claim 26, which is applied to a transparent, conductive layer for storage of information.

28. The coating of claim 26, wherein the information comprises personal information of one or more persons, professional information, company information, recreational information, dictionary information, business records or combinations thereof.
